(19) United States
(12) Patent Application Publication
(10) Pub. No.: US 2026/0032787 A1
(43) Pub. Date: Jan. 29, 2026

(54) GRADIENT MITIGATING HEATING SYSTEM

(71) Applicant: Raytheon Company, Tewksbury, MA (US)

(72) Inventors: Nicholas Gonzalez, Vail, AZ (US); Adam C. Wood, Oro Valley, AZ (US)

(21) Appl. No.: 18/787,395

(22) Filed: Jul. 29, 2024

(51) Int. Cl. H05B 3/00; H05B 1/02

(52) U.S. Cl. CPC H05B 3/0019; H05B 1/0227

(57) ABSTRACT

A thermal gradient management assembly comprising a functional component. The functional component includes an exterior facing segment, where the exterior facing segment is configured to experience aerodynamic heating, and an interior segment with the exterior facing segment, where the interior segment is configured for isolation from the aerodynamic heating. The functional component includes a thermal gradient extending between the exterior facing segment and the interior segment. The thermal gradient management assembly also comprises a gradient mitigating heating system includes a power source and a gradient heating element in communication with the power source, wherein the gradient heating element is coupled with the interior segment. The gradient heating element is configured to diminish the thermal gradient between the exterior facing and the interior segments.

### BACKGROUND

Thermal gradients are a variation in temperature across a physical space or material. For example, the thermal gradient is related to how much temperature changes from one point on a material to another point. In examples, thermal gradients are mathematical descriptions of how a temperature changes or extends across material. Thermal gradients can also describe a change in thermal energy, or heat, when transferred to any secondary materials coupled with the material experiencing an initial thermal gradient.

In examples, thermal energy is transferred from one material to a secondary material through conduction or radiation. Conduction is a process where heat is transferred from a hotter portion of the material to a cooler portion of the material. In some examples, conduction occurs when heat flows along a temperature gradient from a first hotter material to a second cooler material, in contact with each other. During conduction, heat flows within and through the material itself.

Thermal radiation is the transfer of heat between materials that are separated. In some examples, heat is transferred through air spacing the materials from each other. In other examples, thermal radiation occurs when heat is transferred through a low-pressure environment, such as through space. When two materials are coupled, directly or indirectly, heat experienced by an external source can be transferred to a more internal material.

Mechanical stress is a measure of the intensity of internal forces that act within or on a material as that material resists deformation, either from external loads or due to changes in temperature. For example, tensile stress occurs when forces act to stretch or elongate a material. Tensile stress is considered positive, and it pulls on the material, potentially leading to stretching or breaking. In another example, shear stress occurs when forces are applied parallel or tangent to a surface, causing the material to slide over itself internally. In an example, when the material slides over another source the material can fracture along the plane where the force is applied.

Heat causes materials to expand through a process known as thermal expansion. Thermal expansion is a physical behavior observed in most materials when they are heated, directly or indirectly.

### SUMMARY

In high-speed systems, such as in aerospace vehicles, thermal gradients that occur during travel induce thermo-structural stress. For example, if a material is constrained and unable to expand freely when heated, it develops internal stresses known as thermal stresses. These stresses can lead to warping, cracking, or other forms of structural failure if not properly managed. For example, during acceleration, friction generated between the high-speed vehicle and the air in which the vehicle travels induces a heat gradient across exterior facing components. The heat, or thermal energy, experienced by the exterior facing components is transmitted from the hotter surfaces of the exterior facing components to the more interior components coupled with the exterior facing components.

The thermal gradient is, for example, more intense when the vehicle experiences increased acceleration. When the thermal gradient is more intense, the thermal gradient can induce more stress between two coupled components. In some examples, when a vehicle experiences increased acceleration, the exterior facing component expands more than an internal component.

In some systems for managing friction-initiated, thermally induced stress in an aerospace vehicle, the system comprises a structure, or functional component, having an exterior facing segment and an interior segment. The exterior segment, for example, experiences friction-initiated heating and the interior component is isolated from the friction-initiated heating. In some examples, a thermal gradient extends between the exterior facing segment and the interior segment. The system also includes, for example, a gradient mitigating heating system that includes a power source and a gradient heating element in communication with the power source. The gradient heating element is, for example, coupled with the interior segment.

In an example, a control system is in communication with the gradient mitigating heating system. The control system is configured to, for example, adjust heat generated by the gradient mitigating heating system. In an example, the control system controls heat dissipated from the gradient heating element towards the interior component.

For example, the structure, or functional component has an initial configuration where the structure is exposed to a reduced amount of heat, as compared to a stressed induced configuration where the functional component is exposed to an elevated amount of friction-induced heat. In an example, in the initial configuration, the exterior facing segment and the interior segment experience a stable coupling and a minimal amount of stress is experience.

In the stress induced configuration, the exterior facing segment, for example, experiences friction-initiated heating and expands. Also, in the stressed induced configuration, the heat gradient experienced by the interior component induces the interior component to expand or deform. In examples, when in the stressed induced configuration, the functional component is configured to experience stress between the exterior facing segment and the interior segment. The gradient heating element, for example, is configured to diminish the thermal gradient between the exterior facing segment and interior segment.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

FIG. 1 illustrates a thermal gradient management system according to at least one example of the present disclosure.

FIG. 2 illustrates a graphical representation of an explanation differential according to at least one example of the present disclosure.

FIG. 3 illustrates an aerodynamic vehicle according to at least one example of the present disclosure.

FIG. 4A illustrates a schematic of a cross section of a functional component including a thermal gradient management system according to at least one example of the present disclosure.

FIG. 4B illustrates a schematic of a cross section of a functional component including a thermal gradient management system according to at least one example of the present disclosure.

### DETAILED DESCRIPTION

In high-speed systems, especially during boost phase, the system can experience friction induced thermal gradients and heating. For example, the system is exposed to thermal gradients that extend from an exterior facing segment towards a more interior segment. At high acceleration rates, these gradients can be severe, for example, the temperature experienced by the exterior facing segment is greater than the more interior segment.

In examples, when the exterior facing segment experiences an increase in heat, or thermal energy, the exterior facing segment can deform or expand. The exterior facing segment can also transfer heat, such as through conduction, to the interior segment. For example, the transfer of heat from the exterior facing segment to the interior segment results in the interior segment experiencing heat at a later point in time and a different temperature. The difference in temperature is, for example, a gradient change in temperature between the exterior facing segment and the interior segment. The interior segment, experiencing a lower temperature than the exterior facing segment due to the gradient of heat, can expand or deform differently than the exterior facing segment. The differences in expansion or deformation, for example, forms stress concentrations or areas between the exterior facing segment and the interior segment. This can be a physical limitation of high-speed systems. In some examples, the stress induced between the exterior facing segment and the interior segment can cause failures, including, but not limited to catastrophic mission failures.

One method for reducing thermal gradients that, for example, result in increased stress between components is to reduce the effects of heating, such as aerodynamic heating or friction-induced heating, utilizing passive methods such as thermal protection systems. In examples, passive methods include providing a layer of insulation or a heat shield coupled to the components of the high-speed system that are exposed to increasing heat. In some examples, insulation or other passive heat mitigating systems become detached, at least at some points, from the system.

The present system provides a solution to managing, or reducing, a heat induced stress between coupled components. For example, the present system manages friction-initiated, and thermally induced stress in high-speed vehicles such as aerospace vehicles. In some instances, the stress on an aerospace vehicle is recognized (e.g., experienced, incurred) at joints, pockets, coupling point, or areas where on portion is thicker than another adjoining portion. For example, the temperature experienced by the thinner area of a mechanical body is greater than an associated thicker area of the mechanical body.

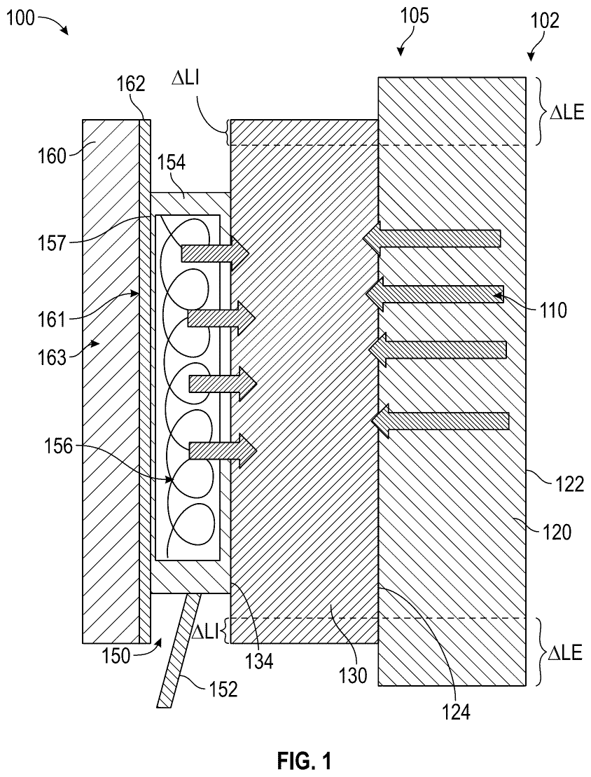

FIG. 1 illustrates an example of a thermal management assembly 100. The thermal management assembly 100 is a system that, for example, mitigates or reduces a thermal gradient 110 experienced by an exterior facing segment 120 and an interior segment 130. In an example, the exterior facing segment 120 and the interior segment 130 are segments (e.g., individual bodies, components, portions) of a functional component 105. The functional component 105 is, for example, a portion of a body 102 such as an airframe, aircraft, space vehicle, effector, land vehicle or the like. In some examples, the functional component 105 includes areas of the body 102 housing electrical components, such as antennas, sensors, circuitry or the like. In other examples, the functional component 105 includes areas of the body 102 having joints or areas coupling two or more segments.

The functional component 105 includes, for example, the exterior facing segment 120 coupled with the interior segment 130. In one instance, the exterior facing segment 120 is positioned as the most exterior portion of the functional component 105. For example, the exterior facing segment 120 includes an exterior face 122 directly exposed to the environment. During movement of the functional component 105, the exterior face 122 directly exposed to the environment experiences or is subjected to, friction-initiated heating. For example, the exterior facing segment 120 is a component of an airframe of an aerospace vehicle and is directly exposed to aerodynamic heating.

In another example, the exterior facing segment 120 is positioning more interiorly from outer surfaces of the body 102. For example, the exterior facing segment 120, while facing an exterior of the body 102, is not the outermost component of the functional component 105. The exterior facing segment 120, for example, while not the outermost component of the functional component 105 still experiences and receives thermal energy, or heat, when the body 102 is moving at high speeds.

The interior segment 130, for example, is positioned more internally relative to the exterior facing segment 120. For instance, the interior segment 130 is coupled to the exterior facing segment 120. The interior segment 130 is, for example, coupled to an interior side 124 of the exterior facing segment 120. In some examples, the interior segment 130 is coupled directly with the interior side 124 of the exterior facing segment 120 such that the interior segment 130 is in contact with at least a portion of the interior segment 130. In another example, an intermediary layer is positioned between the exterior facing segment 120 and the interior segment 130.

The exterior facing segment 120 isolates (e.g., separates) the interior segment 130 from the thermal energy the exterior facing segment 120 experiences. The exterior facing segment 120 isolates the interior segment 130 from the heating experienced by the exterior facing segment 120, while also transferring heat from the exterior facing segment 120 to the interior segment 130. For example, the interior segment 130 is separate from the exterior facing segment 120. The interior segment 130, in another example, is removed, or segregated from the heat experienced by the exterior facing segment 120. In some examples, the exterior facing segment 120 protects the interior segment 130 from direct exposure to the heat experienced by the exterior facing segment 120, such as friction-initiated heating or aerodynamic heating. For instance, the exterior facing segment 120 isolates the interior segment 130 from the higher temperatures experienced by the exterior face 122 of exterior facing segment 120 as compared to internal components of the body 102.

In some examples, the difference in temperature experienced by the exterior face 122 due to the friction-initiated heating (e.g., aerodynamic heating) and the temperature experienced by the interior segment 130 from the conductive relationship between the exterior facing segment 120 and the interior segment 130 is a large differential (e.g., approximately 20 percent differential or greater). The difference in temperature experienced by the exterior face 122 having a large differential is, for example, the result of the interior segment 130 being isolated from the exterior facing segment 120. In other examples, the difference in temperature experienced by the exterior face 122 due to the friction-initiated heating (e.g., aerodynamic heating) and the temperature experienced by the interior segment 130 from the conductive relationship between the exterior facing segment 120 and the interior segment 130 is a small differential (e.g., approximately 20 percent differential or less). The difference in temperature experienced by the exterior face 122 having a small differential is, for example, the result of the interior segment 130 being isolated from the exterior facing segment 120. In other examples, the exterior facing segment 120 isolates the interior segment 130 from direct heat exposure and the thermal gradient 110 between the exterior facing segment 120 and the interior segment 130 is minimal (e.g., the temperature of the interior segment 130 and the exterior facing segment 120 are equivalent, similar or within a small range of temperatures compared to the temperature experienced by the interior segment 130).

The thermal gradient 110 extending between the exterior facing segment 120 and the interior segment 130 can be the differential in heat transferred from the exterior facing segment 120 to the interior segment 130. The thermal gradient 110 can cause the interior segment 130 to increase in temperature as compared to an initial temperature. The thermal gradient 110 can pass to the interior segment 130 due to conduction. The interior segment 130, while isolated from the exterior facing segment 120 can be coupled to the exterior facing segment 120 via a conductive relationship. For instance, the interior segment 130 increases in temperature when the exterior facing segment 120 experiences friction-induced heating because the heat is transferred from the exterior face 122 through the exterior facing segment 120 to the interior side 124 (as a cooler side of the exterior facing segment 120) and into the interior segment 130.

The increase in temperature experienced by the exterior facing segment 120 and the interior segment 130 can cause the exterior facing segment 120 and the interior segment 130 to deform or expand. For example, the friction-initiated heating (e.g., aerodynamic heating, airflow, or the like) can cause the exterior facing segment 120 to expand a first exterior differential ΔLE. The first exterior differential ΔLE is, for example, the difference between the exterior facing segment 120 at a stable condition and exterior facing segment 120 experiencing friction-induced heating. The stable condition includes, for example, when the body 102 experiences a reduced expansion (e.g., no expansion or minimal expansion compared to the dimensions of the exterior facing segment 120 or the body 102).

The increase in temperature experienced by the interior segment 130 is, for example, conduction transmitted from the exterior facing segment 120. For instance, the thermal gradient 110 extending from the exterior facing segment 120 to the interior segment 130 can cause the temperature of the interior segment 130 to increase. For example, the conductive-based heating can cause the interior segment 130 to expand an interior differential ΔLI. The interior differential ΔLI is, for example, the difference between the interior segment 130 at a stable condition and the interior segment 130 experiencing heating from the thermal gradient 110. The stable condition includes, for example, when the body 102 experiences a reduced expansion (e.g., no expansion or minimal expansion compared to the dimensions of the interior segment 130 or the body 102).

When the interior segment 130 and the exterior facing segment 120 are heated, either by friction-initiated heating or conductive heating, the interior segment 130 and the exterior facing segment 120 each can expand. In some examples, the expansion of the exterior segment is the exterior differential ΔLE and the expansion of the interior segment is the interior differential ΔLI. For example, the exterior differential ΔLE and the interior differential and the interior differential ΔLI are different values. In one example, the interior differential ΔLI is less than the exterior differential ΔLE.

In examples with different amounts of expansion for the interior differential ΔLI and the exterior differential ΔLE, stresses can form between the exterior facing segment 120 and the interior segment 130. In a stressed induced configuration, the exterior facing segment 120, for example, experiences an exterior differential ΔLE expansion (e.g., deformation, alteration or the like) in response to friction-initiated heating and the interior segment can experience an interior differential ΔLI expansion (e.g., deformation, alteration or the like) in response to the thermal gradient 110.

For example, when there is a large thermal gradient differential between a first surface, such as the exterior facing segment 120, and the second surface, such as the interior segment 130 a stress gradient is also a large stress differential between the exterior facing segment 120 and the interior segment 130. For example, a high (e.g., intense, large, or the like) thermal gradient can induce thermo-structural stress. At high acceleration rates, the thermal gradient can be a large differential and can induce more stress to the functional component 105. The increase in the stress gradient can be a physical limitation of high-speed systems, as certain failures can cause catastrophic mission failures.

To counter an intense thermal gradient between the exterior facing segment 120 and the interior segment 130, a gradient mitigating gradient heating system 150 is coupled with the interior segment 130. The gradient heating system 150 can include a power source 152 and a gradient heating element 154. The gradient heating system 150, for example, assists in mitigating the thermal gradient 110. For instance, if the thermal gradient 110 is an intense thermal gradient (e.g., large differential compared the functional component at rest), the gradient heating system 150 including the gradient heating element 154 can assist in reducing the thermal gradient 110 realized by the interior segment 130.

For example, the gradient heating element 154 can provide heat, or thermal energy, is coupled to a cool side 134 of the interior segment 130. The gradient heating element 154, for example, inputs energy (e.g., thermal energy, heat) into the interior segment 130. The gradient heating element 154 can include heating coils, such as high emissivity heating coils to radiate thermal energy towards the interior segment 130. In an example, heating coils 156 emit heat, such as through radiation or convection, towards the interior segment 130. In another example, the heating coils 156 are contained within the gradient heating element 154 and the gradient heating element 154 is coupled with the interior segment 130 in a conductive heating relationship.

The heating coils 156 are, for example, formed from one or more of tantalum, silicon carbide, or the like. In examples with the heating coils 156 supplying radiative heat or convective heat, the heating coils 156 can be painted, coated, or otherwise colored black or other dark color to increase radiative heat exchange between the gradient heating element 154 and the cool side 134 of the interior segment 130.

The heat radiated to the cool side 134 of the interior segment 130 can be spread through the interior segment 130 to elevate the temperature of the interior segment 130. The elevation in temperature of the interior segment 130 can bring the interior segment 130 into an acceptable differential between the interior segment 130 and the exterior facing segment 120. In examples, the difference in temperature between the interior segment 130 depends on the design of the functional component 105 and the materials used to form the exterior facing segment 120, interior segment 130 and any intermediary structures that may affect the temperature of the functional component 105. In some instances, the environmental conditions the functional component 105 experiences affect the acceptable range of temperature differential between the interior segment 130 and the exterior facing segment 120. For instance, the acceptable range of temperature differential is a range where stress-induced damage or failure to the functional component 105, the body 102, or the thermal management assembly 100. In some examples, other stresses can be induced by increased the temperature of the cool side 134 of the interior segment 130. When increasing the temperature that induces other stresses, there can be acceptable amount of the other stress that can be tolerated by the thermal management assembly 100 before failure. In some examples, the temperature of the cool side 134 of the interior segment 130 is increased enough to reduce the stress induced from the thermal gradient 110 between the exterior facing segment 120 and the interior segment 130, but not so much that other problems are introduced into the thermal management assembly 100.

In some examples, the stress experienced between the exterior facing segment 120 and the interior segment 130 is proportional to an expansion difference of the exterior facing segment 120 and the interior segment 130. The expansion difference (ED) is the difference between the exterior differential ΔLE and the interior differential ΔLI. The following equation can be used to determine the amount of heat (Q) input into the system, or any of the other variable to determine an adequate thermal management assembly:

$${σ}_{joint} ∝ ED = Δ {L}_{Hot} - α {L}_{0} \frac{Q}{{mC}_{p}} .$$

The stress at the joint (σⱼₒᵢₙₜ) is proportional to the expansion different (ED). This proportionality is equivalent to the difference in the expansion ΔL of each of the materials, individually, when the exterior facing segment 120 and interior segment 130 is in a stable configuration and when in an expanded configuration (e.g., subject to heat). For instance, the expansion difference (ED) is the difference of the expansion of both components. The final input into this solution is power input (from heater). The amount of heat (Q) to be input into the interior segment 130 can be determined by solving for the change in temperature required (ΔT) to minimize the expansion difference and stress to an acceptable margin. In an example, the change in temperature is equal to the ratio of power (Q) to the mass (m) multiplied by the specific heat:

$$\frac{Q}{mCp} .$$

For example, the difference in expansion (ΔL) is for example, the stress (α) multiplied by the original length L₀ and the change in temperature (ΔT).

In an example, to regulate the heat emitting from the gradient heating element 154 insulation 160 is coupled or placed proximate to the gradient heating element 154. For example, the insulation 160 is proximate to an interior side 157 of the gradient heating element 154. The insulation 160 can assist in the energy from the gradient heating element 154 is emitted to the interior segment 130 and reduces the heat radiated away from the gradient heating element 154 towards more interior components of the body 102.

In an initial functional component configuration, for example, with the gradient heating element 154 not activated, or emitting a reduced amount of heat, the exterior facing segment and the interior segment are configured to experience a stable coupling. For example, there is a reduced or tolerable amount of stress between the exterior facing segment and the interior segment. As the high-speed vehicle, such as an aerospace vehicle (e.g., aircraft, spacecraft, effector, or the like), is in use and experiences friction-initiated heating (e.g., aerodynamic heating), the exterior facing segment can increase in temperature and conductively transfer heat to the interior segment. When the temperatures experienced by the exterior facing segment increases, the functional component can be in a stressed induced configuration. In the stressed induced configuration, the exterior facing segment is configured to experience an exterior segment expansion in response to friction-initiated heating and the interior segment is configured to experience an interior segment expansion in response to the thermal gradient, the interior segment expansion different than the exterior facing segment expansion. In an example, in the stressed induced configuration, the functional component is configured to experience stress between the exterior facing segment and the interior segment and the gradient heating element is configured to diminish the thermal gradient between the exterior facing segment and interior segment.

Optionally, a reflective layer 162 is coupled to or placed proximate to the insulation 160. The reflective layer 162 can be coupled to or positioned proximate to an exterior facing portion 161 of the insulation 160. In another example, the reflective layer 162 is coupled with an interior facing portion 163 of the insulation 160. The reflective layer 162, for example, reflects heat emitted from the gradient heating element 154 toward the interior segment 130. In an example, using the insulation 160 and the reflective layer 162 increases the amount of heat emitted from the gradient heating element 154 that is received by the interior segment 130.

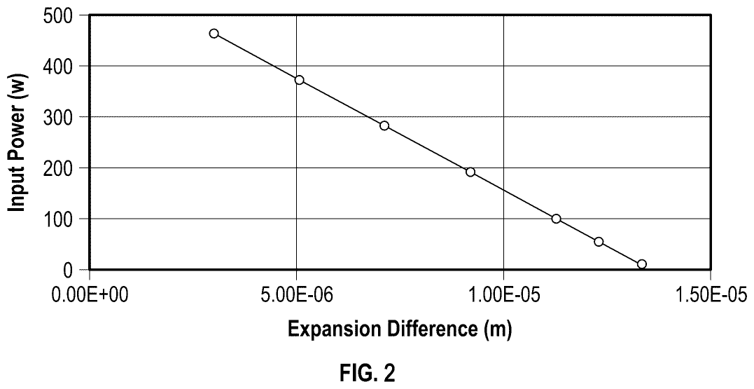

FIG. 2 is an example of the expansion difference graphically illustrated. The graph contemplates the exterior facing segment (e.g., exterior facing segment 120 in FIG. 1) is formed from Inconel 718 and the interior segment is 17-4 stainless steel. The exterior facing segment is exposed to a temperature of approximately 1300 degrees Fahrenheit (approximately 704 Celsius). In the example, it is contemplated that the exterior facing segment and the interior segment have the same thickness of approximately 0.07 inches (approximately 0.178 centimeters). In the example, the heated area is assumed to be approximately 6 inches by 6 inches (approximately 15.24 centimeters). The exterior facing segment is heated to 1300 degrees Fahrenheit for approximately 60 seconds. As illustrated in the graph, when the input power by the is approximately zero the expansion difference (ED) between the exterior facing segment and the interior segment is approximately 1.30E-05 meters. As the input power increases the expansion different (ED) decreases. For instance, when the input power is increased to approximately 380 watts, the expansion difference is approximately 5.00E-06. In another instance, as the input power approaches 500 watts, the expansion different (ED) approaches 0.00E+0 meters.

For example, as the thermal gradient, discussed previously, or the difference in temperature between the exterior facing segment and the interior segment approaches a thermal equilibrium, the stress gradient can also approach a stress equilibrium. For instance, as the stress gradient decreases the likelihood of damage or failure to the thermal management assembly 100 (of FIG. 1) is reduced.

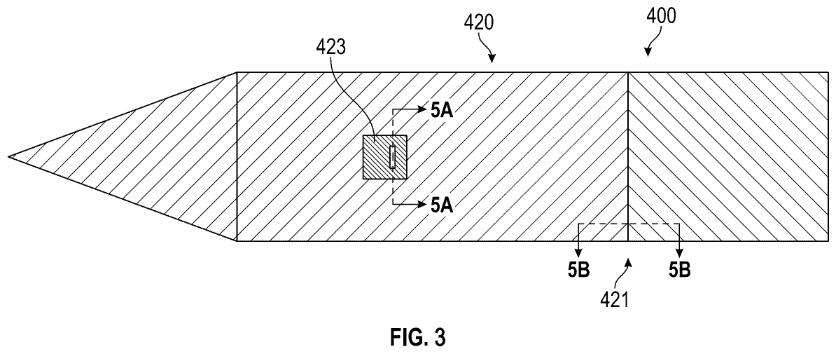

FIG. 3 illustrates, for example a schematic of an aerodynamic vehicle 400 as a high-speed vehicle. The aerodynamic vehicle 400 includes an exterior facing segment 420 as an airframe. The exterior facing segment 420 of the aerodynamic vehicle 400 includes, for example, the mechanical structure of the aerodynamic vehicle 400. The exterior facing segment 420 includes, for example, a fuselage, undercarriage, empennage, wings, and the like. In other examples, the exterior facing segment 420 includes engine casings or other mechanical components that are subject to friction-initiated heating, such as aerodynamic heating. The exterior facing segment 420 includes, for instance, a portion of the aerodynamic vehicle 400, such as coupled portions of a joint 421 of the airframe. In another example, the exterior facing segment 420 includes, for instance portions of the aerodynamic vehicle 400 surrounding an antenna 423.

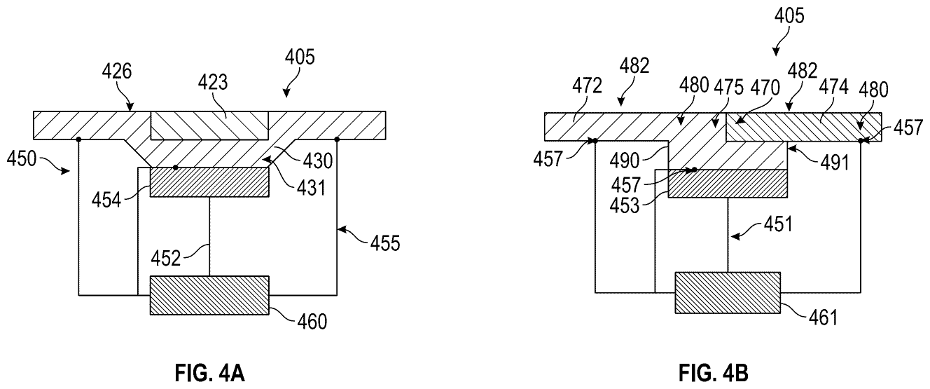

FIG. 4A is a cross-section taken at A-A of FIG. 3. FIG. 4A includes a cross-section of a functional component 405 including the antenna 423. In an example, the exterior facing segment 420 includes antenna surrounding portions 426 of the aerodynamic vehicle 400 and an interior segment 430 includes the antenna pocket 431. The interior segment 430 is, for example, isolated from the exterior facing segment 420. For instance, the interior segment 430 is shielded, removed, separated or the like from thermal energy that the exterior facing segment 420 may experience.

In use, the exterior facing segment 420 experiences, for example, aerodynamic heating, or friction-induced heating. The antenna 423 can shield the interior segment 430 from the aerodynamic heating. For instance, the interior segment 430 experiences a lower temperature than the exterior facing segment 420 when the interior segment 430 experiences aerodynamic heating. The difference in temperature can cause increases the stresses occurring in surfaces surrounding the antenna 423 or the antenna surrounding portions 426.

In some examples, the exterior facing segment 420 includes the portion of the aerodynamic vehicle 400 that are directly exposed to aerodynamic heating. The exterior facing segment 420 can be in thermally conductive contact with the interior segment 430. For instance, the interior segment 430 includes a portion under the exterior facing segment 420, such as the material under as a recess that forms the antenna pocket 431.

The functional component 405 includes a gradient heating system 450 coupled to an interior portion of the interior segment 430. In an example, the gradient heating system 450 includes a gradient heating element 454 coupled to the interior segment 430. The gradient heating system 450 also includes a power source 452. The power source 452 can include one or more of a battery, a vehicle power system or a source of waste heat. The gradient heating element 454 can provide heat, or thermal energy, towards the interior segment 430.

The gradient heating system 450 can be coupled with a control system 460. The control system 460, for example, includes systems that can control or regulate the amount of heat that is supplied from the gradient heating element 454 towards the interior segment 430. In another example, the control system 460 can control the amount of time the gradient heating element 454 supplies heat towards the interior segment 430. In some instances, the control system 460 can be in communication with control systems on the aerodynamic vehicle 400.

The gradient heating system 450 can also include sensors 455 such as thermocouples, temperature sensors, stress measuring sensors, or displacement sensors. The sensors 455 can be in communication with the control system 460. The sensors 455 can be positioned relative to one or more of the airframe, such as the exterior facing segment 420, the interior segment 430 or the gradient heating element 454. The sensors 455 can be in communication with the control system 460 to provide information to the control system 460. The information provided to the control system 460 can indicate to the control system 460 to adjust the temperature or the time the temperature is emitted towards the interior segment 430.

The control system 460 can provide communication to the gradient heating element 454 to increase the temperature of the interior segment 430. Increasing the temperature of the interior segment 430 can reduce the likelihood that the functional component 405 will fail or become damaged, or components of the functional component 405 will fail or become damaged.

FIG. 4B illustrates an example of a cross-section B-B of aerodynamic vehicle 400. The cross-section B-B is an example of a joint 470 between a forward portion 472 and an aft portion 474 of the aerodynamic vehicle 400. The forward portion 472 and aft portion 474 that have exterior faces 482 are examples of an exterior facing segment 480. In an example, the exterior faces 482 are exposed directly to aerodynamic heating (e.g., friction-initiated heating). In another example, the exterior faces 482 are covered, encased, or protected from direct exposure to aerodynamic heating.

In an example of FIG. 4B, at least one joint section 475 of the forward portion 472 couples with the aft portion 474, such as under the aft portion 474. In another example, a portion of the aft portion 474 couples with the forward portion 472 such as extending under the forward portion 472, as another example of at least one joint segment. The at least one joint section 475 is an example of an interior segment 490. The interior segment 490 is not directly exposed to the aerodynamic heating that the exterior facing segment 480 is exposed to. For example, the interior segment 490 is a lower temperature than the exterior facing segment 480.

To counter the thermal gradient between the exterior facing segment 480 and the interior segment 490 a gradient heating system 451 is coupled to a more interior portion 491 of the interior segment 490. The gradient heating system 451 of FIG. 4B is similar to the gradient heating system 150 and 450 of FIGS. 1 and 4A, respectively. For example, the gradient heating system 451 includes a gradient heating element 453. The gradient heating element 453 can increase the temperature of the interior segment 490 to reduce the thermal gradient between the exterior facing segment 480 and the interior segment 490.

Optionally, the gradient heating system 451 includes one or more sensors 457. The one or more sensors 457 can be similar to the sensors 455 of FIG. 4A. The one or more sensors 457 can be coupled with one or more of the forward portion 472, aft portion 474 and the at least one joint section 475. In an example, the one or more sensors 457 is also in communication with the interior segment 490 proximate to the gradient heating element 453.

The gradient heating system 451 can be in communication with a control system 461. The control system 461 can be similar to the control system 460 of FIG. 4A. The control system 461 can receive or provide communication to the gradient heating element 453 to control the temperature emitted from the gradient heating element 453 towards the interior segment 490. For example, controlling the temperature emitted from the gradient heating element 453 can control the temperature of the interior segment 490 to reduce the likelihood of damage or failure to the functional component 405.

### Aspects

Aspect 1 can include subject matter such as a system for managing friction-initiated, thermally-induced stress in an aerospace vehicle, the system comprising: a functional component including: an exterior facing segment, wherein the exterior facing segment is configured to experience friction-initiated heating; wherein the exterior facing segment is configured to deform when experiencing friction-initiated heating; and an interior segment coupled with the exterior facing segment, wherein the interior segment is configured for isolation from the friction-initiated heating; wherein the functional component includes a thermal gradient extending between the exterior facing segment and the interior segment; a gradient mitigating heating system including: a power source; and a gradient heating element in communication with the power source, wherein the gradient heating element is coupled with the interior segment; a control system in communication with the gradient mitigating heating system, the control system is configured to adjust heat generated by the gradient mitigating heating system; and a gradient mitigating heating configuration including an initial functional component configuration and a stressed induced configuration; wherein in the initial functional component configuration, the exterior facing segment and the interior segment are configured to experience a stable coupling; and wherein in the stressed induced configuration, the exterior facing segment is configured to experience an exterior segment expansion in response to friction-initiated heating and the interior segment is configured to experience an interior segment expansion in response to the thermal gradient, the interior segment expansion different than the exterior facing segment expansion; wherein the stressed induced configuration, the functional component is configured to experience stress between the exterior facing segment and the interior segment and the gradient heating element is configured to diminish the thermal gradient between the exterior facing segment and interior segment.

Aspect 2 can include, or can optionally be combined with the subject matter of Aspect 1, to optionally include one or more the interior segment is in thermally conductive contact with the exterior facing segment.

Aspect 3 can include, or can optionally be combined with the subject matter of one or any combination of Aspects 1 or 2 to optionally include the exterior facing segment is an exterior of an aerodynamic vehicle.

Aspect 4 can include, or can optionally be combined with the subject matter of one or any combination of Aspects 1 to 3 to optionally include the gradient heating element is configured to emit radiative heat towards the interior segment.

Aspect 5 can include, or can optionally be combined with the subject matter of one or any combination of Aspects 1 to 4 to optionally include insulation coupled to the gradient heating element.

Aspect 6 can include, or can optionally be combined with the subject matter of one or any combination of Aspects 1 to 5 to optionally include the functional component includes one or more antenna pockets.

Aspect 7 can include, or can optionally be combined with the subject matter of one or any combination of Aspects 1 to 6 to optionally include the control system is coupled with one or more of the exterior facing segment or the interior segment.

Aspect 8 can include subject matter such as a thermal gradient management assembly comprising: a functional component including: an exterior facing segment, wherein the exterior facing segment is configured to experience aerodynamic heating; and an interior segment with the exterior facing segment, wherein the interior segment is configured for isolation from the aerodynamic heating; wherein the functional component includes a thermal gradient extending between the exterior facing segment and the interior segment; and a gradient mitigating heating system, wherein the gradient mitigating heating system includes: a power source; and a gradient heating element in communication with the power source, wherein the gradient heating element is coupled with the interior segment; and wherein the gradient heating element is configured to diminish the thermal gradient between the exterior facing and the interior segments.

Aspect 9 can include, or can optionally be combined with the subject matter of one or any combination of Aspects 8 to optionally include the interior segment is in thermally conductive contact with the exterior facing segment.

Aspect 10 can include, or can optionally be combined with the subject matter of one or any combination of Aspects 8 or 9 to optionally include the interior segment is integral to the exterior facing segment.

Aspect 11 can include, or can optionally be combined with the subject matter of one or any combination of Aspects 8 to 10 to optionally include the exterior facing segment is proximate to an exterior of an aerodynamic vehicle and the interior segment is remote to the exterior of the aerodynamic vehicle in comparison to the exterior facing segment.

Aspect 12 can include, or can optionally be combined with the subject matter of one or any combination of Aspects 8 to 11 to optionally include the exterior facing segment is an exterior of an aerodynamic vehicle.

Aspect 13 can include, or can optionally be combined with the subject matter of one or any combination of Aspects 8 to 12 to optionally include the functional component includes an electrical component.

Aspect 14 can include, or can optionally be combined with the subject matter of one or any combination of Aspects 8 to 13 to optionally include the functional component includes an airframe joint; wherein the airframe joint includes a for portion as the exterior facing segment and an aft portion as the interior segment.

Aspect 15 can include, or can optionally be combined with the subject matter of one or any combination of Aspects 8 to 14 to optionally include the power source includes one or more of a battery, a vehicle power system, or a source of waste heat.

Aspect 16 can include subject matter such as a thermal gradient management system for a high-speed vehicle comprising: a functional component including: an exterior facing segment, wherein the exterior facing segment is configured to experience friction induced heating; wherein the exterior facing segment is configured to expand when experiencing friction-induced heating; and an interior segment coupled with the exterior facing segment, wherein the interior segment is configured for isolation from the friction-induced heating; wherein the functional component includes a thermal gradient extending between the exterior facing segment and the interior segment; wherein the interior segment is configured to expand in response to the thermal gradient; and a gradient mitigating heating system, wherein the gradient mitigating heating system includes: a power source; and a gradient heating element in communication with the power source, wherein the gradient heating element is coupled with the interior segment; wherein the gradient heating element is configured to diminish the thermal gradient between the exterior facing segment and the interior segment; and wherein the interior segment is configured to correspondingly expand relative to the exterior facing segment.

Aspect 17 can include, or can optionally be combined with the subject matter of one or any combination of Aspects 16 to optionally include the power source includes a battery, a vehicle power system or a source of waste heat.

Aspect 18 can include, or can optionally be combined with the subject matter of one or any combination of Aspects 16 or 17 to optionally include the gradient mitigating heating system is configured to mitigate an induced stress between the exterior facing segment and the interior segment.

Aspect 19 can include, or can optionally be combined with the subject matter of one or any combination of Aspects 16 to 18 to optionally include a control system coupled with one or more of the gradient heating element, the exterior facing segment or the interior segment.

Aspect 20 can include, or can optionally be combined with the subject matter of one or any combination of Aspects 16 to 19 to optionally include the high-speed vehicle is an aerospace vehicle.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A system for managing friction-initiated, thermally-induced stress in an aerospace vehicle, the system comprising:
a functional component including:
an exterior facing segment, wherein the exterior facing segment is configured to experience friction-initiated heating;
wherein the exterior facing segment is configured to deform when experiencing friction-initiated heating; and
an interior segment coupled with the exterior facing segment, wherein the interior segment is configured for isolation from the friction-initiated heating;
wherein the functional component includes a thermal gradient extending between the exterior facing segment and the interior segment;
a gradient mitigating heating system including:
a power source; and
a gradient heating element in communication with the power source, wherein the gradient heating element is coupled with the interior segment;
a control system in communication with the gradient mitigating heating system, the control system is configured to adjust heat generated by the gradient mitigating heating system; and
a gradient mitigating heating configuration including an initial functional component configuration and a stressed induced configuration;
wherein in the initial functional component configuration, the exterior facing segment and the interior segment are configured to experience a stable coupling; and
wherein in the stressed induced configuration, the exterior facing segment is configured to experience an exterior segment expansion in response to friction-initiated heating and the interior segment is configured to experience an interior segment expansion in response to the thermal gradient, the interior segment expansion different than the exterior facing segment expansion;
wherein the stressed induced configuration, the functional component is configured to experience stress between the exterior facing segment and the interior segment and the gradient heating element is configured to diminish the thermal gradient between the exterior facing segment and interior segment.

2. The system of claim 1, wherein the interior segment is in thermally conductive contact with the exterior facing segment.

3. The system of claim 1, wherein the exterior facing segment is an exterior of an aerodynamic vehicle.

4. The system of claim 1, wherein the gradient heating element is configured to emit radiative or convective heat towards the interior segment.

5. The system of claim 1, including insulation coupled to the gradient heating element.

6. The system of claim 1, wherein the functional component includes one or more antenna pockets.

7. The system of claim 1, wherein the control system is coupled with one or more of the exterior facing segment or the interior segment.

8. A thermal gradient management assembly comprising:
a functional component including:
an exterior facing segment, wherein the exterior facing segment is configured to experience aerodynamic heating; and
an interior segment with the exterior facing segment, wherein the interior segment is configured for isolation from the aerodynamic heating;
wherein the functional component includes a thermal gradient extending between the exterior facing segment and the interior segment; and
a gradient mitigating heating system, wherein the gradient mitigating heating system includes:
a power source; and
a gradient heating element in communication with the power source, wherein the gradient heating element is coupled with the interior segment; and
wherein the gradient heating element is configured to diminish the thermal gradient between the exterior facing and the interior segments.

9. The thermal gradient management assembly of claim 8, wherein the interior segment is in thermally conductive contact with the exterior facing segment.

10. The thermal gradient management assembly of claim 8, wherein the interior segment is integral to the exterior facing segment.

11. The thermal gradient management assembly of claim 8, wherein the exterior facing segment is proximate to an exterior of an aerodynamic vehicle and the interior segment is remote to the exterior of the aerodynamic vehicle in comparison to the exterior facing segment.

12. The thermal gradient management assembly of claim 8, wherein the exterior facing segment is an exterior of an aerodynamic vehicle.

13. The thermal gradient management assembly of claim 8, wherein the functional component includes an electrical component.

14. The thermal gradient management assembly of claim 8, wherein the functional component includes an airframe joint;
wherein the airframe joint includes a for portion as the exterior facing segment and an aft portion as the interior segment.

15. The thermal gradient management assembly of claim 8, wherein the power source includes one or more of a battery, a vehicle power system, or a source of waste heat.

16. A thermal gradient management system for a high-speed vehicle comprising:
a functional component including:
an exterior facing segment, wherein the exterior facing segment is configured to experience friction induced heating;
wherein the exterior facing segment is configured to expand when experiencing friction-induced heating; and
an interior segment coupled with the exterior facing segment, wherein the interior segment is configured for isolation from the friction-induced heating;
wherein the functional component includes a thermal gradient extending between the exterior facing segment and the interior segment;
wherein the interior segment is configured to expand in response to the thermal gradient; and
a gradient mitigating heating system, wherein the gradient mitigating heating system includes:
a power source; and
a gradient heating element in communication with the power source, wherein the gradient heating element is coupled with the interior segment;
wherein the gradient heating element is configured to diminish the thermal gradient between the exterior facing segment and the interior segment; and
wherein the interior segment is configured to correspondingly expand relative to the exterior facing segment.

17. The thermal gradient management system of claim 16, wherein the power source includes a battery, a vehicle power system or a source of waste heat.

18. The thermal gradient management system of claim 16, wherein the gradient mitigating heating system is configured to mitigate an induced stress between the exterior facing segment and the interior segment.

19. The thermal gradient management system of claim 16, including a control system coupled with one or more of the gradient heating element, the exterior facing segment or the interior segment.

20. The thermal gradient management system of claim 16, wherein the high-speed vehicle is an aerospace vehicle.
